(19) United States
(12) Patent Application Publication
(10) Pub. No.: US 2025/0059760 A1
(43) Pub. Date: Feb. 20, 2025

(54) INTEGRATED WINDOW

(71) Applicant: Mercer Mass Timber LLC, Spokane Valley, WA (US)

(72) Inventors: Kevin Dwayne VILHAUER, Puyallup, WA (US); Gregory James LAMBAS, Post Falls, ID (US); John James DWYER, Plano, TX (US)

(21) Appl. No.: 18/820,007

(22) Filed: Aug. 29, 2024

Related U.S. Application Data
(63) Continuation of application No. 17/186,942, filed on Feb. 26, 2021, now abandoned.
(60) Provisional application No. 62/983,190, filed on Feb. 28, 2020.

(51) Int. Cl. E04B 2/56; E04B 2/58; E04B 2/70; E06B 1/36

(52) U.S. Cl. CPC E04B 2/56; E04B 2/58; E04B 2/70; E06B 1/36; E04B 2002/565

(57) ABSTRACT

A prefabricated integrated window and wall is provided. The prefabricated integrated window and wall includes a window frame, a wall, and a power system. The window frame is configured to hold a variety of different windows. The window frame includes a frame head and a sill. The frame head includes a channel. The sill includes tabs. The wall is configured around the window frame. The wall is configured to connect to the tabs of the sill and the channel of the frame head. The power system is molded into the window frame. A method of assembling the prefabricated integrated window and wall is also provided.

### CROSS-REFERENCE TO RELATED APPLICATIONS

This application is a continuation of U.S. patent application Ser. No. 17/186,942, filed on Feb. 26, 2021, which claims the benefit of U.S. Provisional Application No. 62/983,190, filed Feb. 28, 2020, the entire contents of which are hereby incorporated by reference herein.

### FIELD OF INVENTION

The present invention relates generally to construction, and more specifically to construction of a wall frame and window frame.

### BACKGROUND

Typically a window is framed in the wall during the wall framing process. There are several components of a window frame. Installing these window framing components piece-by-piece slows down the wall framing process. Window framing components include a header, window sill, studs running from the ends of the header down to the window sill, and trimmers. Weatherproofing and insulation are also installed. The window is then installed with its own components including weatherproofing and insulation. The design of each element is sub-optimized due to compromises and overlaps in functional characteristics. For example, the window has weatherproofing and insulation components and the wall has weatherproofing and insulation components. Thus, integrating traditional window elements into preassembled walls is an inherently inefficient process. Moreover, traditional integration methods lack the facility to enable electrical connectivity to supply sensors, motors, or other powered enhancements to the window.

### SUMMARY

A prefabricated integrated window and wall is provided. The prefabricated integrated window and wall includes a window frame, a wall, and a power system. The window frame is configured to hold a variety of different windows. The window frame includes a frame head and a sill. The frame head includes a channel. The sill includes tabs. The wall is configured around the window frame. The wall is configured to connect to the tabs of the sill and the channel of the frame head. The power system is molded into the window frame.

A method of assembling a prefabricated integrated window and wall is provided. The method includes receiving a window frame, building a wall around the window frame, and routing electrical power wiring. The window frame is configured to hold a variety of different windows. The window frame includes a frame head and a sill. The frame head includes a channel. The sill includes tabs. The window frame includes a power system. The wall is built around the window frame by attaching wall frame components to the tabs of the sill and the channel of the frame head. The electrical power wiring is routed to the power system of the window frame.

### BRIEF DESCRIPTION OF THE DRAWINGS

The foregoing summary, as well as the following detailed description will be better understood when read in conjunction with the appended drawings. For the purpose of illustration, there is shown in the drawings different embodiments. It should be understood, however, that the teachings are not limited to the precise integrated window and wall system shown.

FIG. 1 shows a perspective view of a prefabricated integrated window and wall system.

FIG. 2 shows a perspective view of a window frame.

FIG. 3 shows a progression of the wall being built around the window frame.

FIG. 4 shows a section of the window frame.

FIG. 5 shows a section of the window frame with trim attached.

FIG. 6 shows a section of the window frame with an accessory attached to the frame.

FIG. 7 shows the integrated power system in the window frame.

FIG. 7A shows a magnified view of the integrated power system molded into the frame of FIG. 7.

FIG. 8 shows a flow chart of assembling a p1⋅efabricated integrated window and wall.

### DETAILED DESCRIPTION

A prefabricated integrated window and wall system is provided. The integrated window frame includes a wall and a window frame which is specifically designed to hold a window element. The window frame is built into the wall and is developed to enable a window of any given size. The window frame also integrates electrical connectivity. The integrated window and wall system is designed to optimize components by overlapping and integrating window and wall elements.

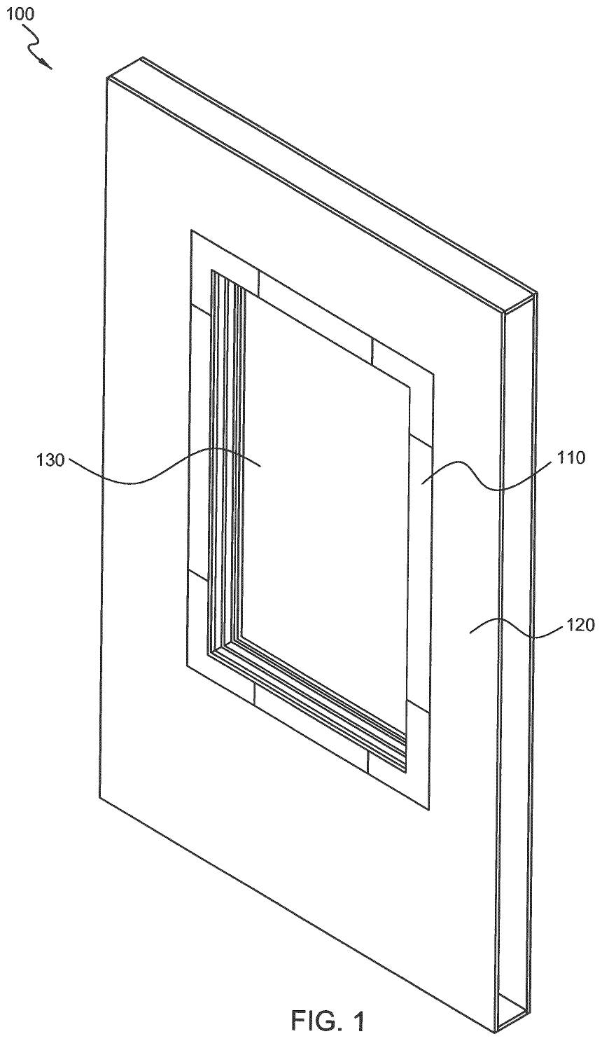

FIG. 1 shows a perspective view of a prefabricated integrated window and wall system 100. The prefabricated integrated window and wall system 100 includes a window frame 110 and a wall 120. The system 100 allows the window frame 110 and wall 120 to be built simultaneously. The system 100 integrates the window frame 110 and wall 120 design and materials. The system 100 saves material, saves time it takes to construct a wall with window, and ultimately saves cost. The window frame 110 is configured to hold and secure a window 130 within the frame 110. The frame 110 is able to hold and secure a variety of operating window 130 styles. The window 130 styles may include direct glaze fixed, fixed sash casement, casement, awning, horizontal slider, and single hung. The window frame 110 also includes a power system (not visible in FIG. 1). The power-system may include a bus bar that delivers power to the system 100. The window frame 110 may include room for accessories such as electronics, roller shade and blind housings, retractable screens, etc. The power system may supply power to the accessories. The system 100 is prefabricated and shipped to the work site. The design of the prefabricated integrated window and wall system 100 allows the wall 120 with the window frame 110 and window 130 to be shipped flat to the work site. Once at the work site, the wall may be quickly and easily installed with the window frame 110 and window 130 already installed in the wall 120. The system 100 also integrates the seal and insulation of the window frame 110 and the wall 120 which provides a better sealing method of the window frame 110 and wall 120. The system 100 may also incorporate hardware integration, reduction, and automation.

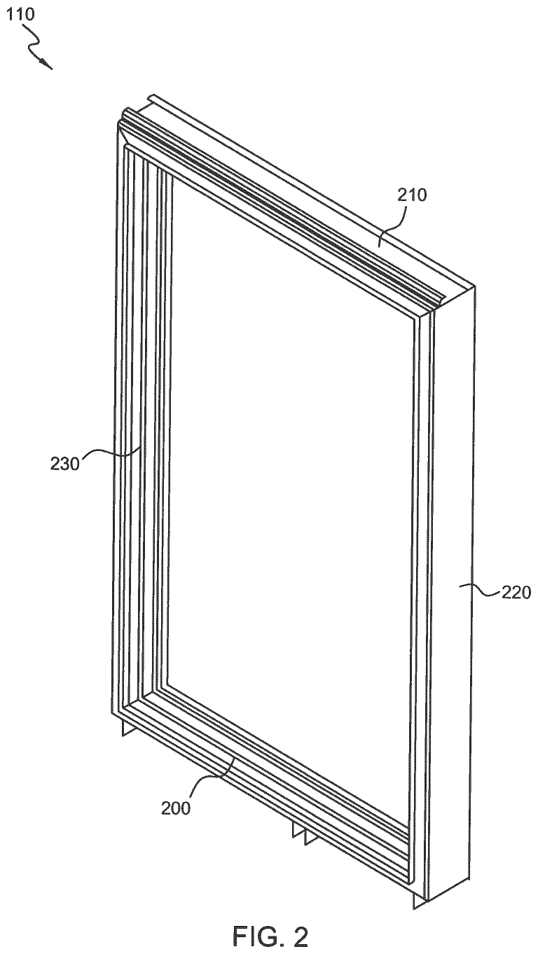

FIG. 2 shows a perspective view of the window frame 110. The frame 110 may be a solid design as shown in FIG. 1. Alternatively, the frame 110 may be designed with hollows or channels to reduce weight which also reduces cost. The window frame 110 includes a sill 200, frame head 210, and studs 220, 230. The sill 200 may include built-in features under or within the sill 200 that allows the wall 120 to be connected to the window frame 110. The built-in features may be tabs that are configured to attach to wall frame components of the wall 120. The frame head 210 may include a channel that allows a wall header of the wall 120 to connect to the window frame 110 and allow load transfer to the header. As previously discussed, the window frame 110 allows for various operating style windows such as direct glazed fixed, sash-set fixed, projection windows such as casement, awning and parallel, and both vertical and horizontal sliding windows. Some operating styles may be accomplished by adding additional components to the frame. Additional components may include PVC extrusions. The window frame 110 may be molded. The frame 110 may be molded with recesses, holes, screw bosses, etc. for attachment of hardware and other optional accessories.

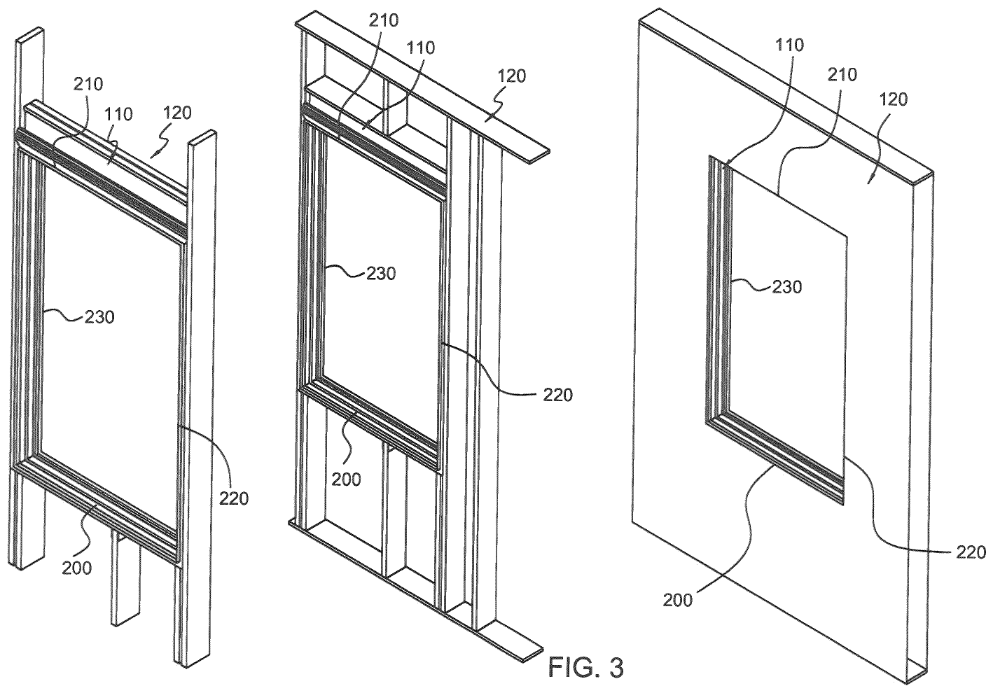

FIG. 3 shows a progression of the wall 120 being built around the window frame 110. The wall 120 is built around the window frame 110. Wall 120 framing components may be attached to the window frame 110 via the tabs under the sill 200 of the window frame 110 and the channel in the frame head 210. Once the wall 120 framing components are attached to the window frame 110, the rest of the wall 120 is framed. Electrical power wiring may be routed to the window frame 110 within the wall 120. More specifically, the electrical power wiring may be routed to the power system in the window frame 110. The wall framing of the wall 120 may be wood or cold formed steel.

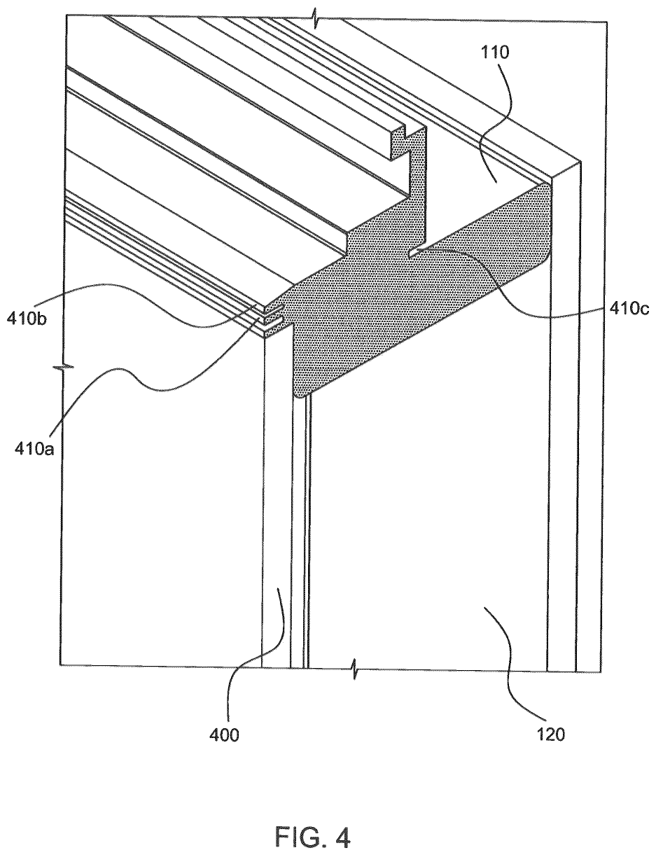

FIG. 4 shows a section of the window frame 110. The window frame 110 sits flush with the exterior sheathing 400 of the wall 120. Because the window frame 110 sits flush with the exterior sheathing 400, the wall and window system 110 may be stacked horizontally and shipped to a final location. The glass and/or sashes are recessed into the wall 120. The glass and/or sashes are installed in the factory or in the field after the wall 120 is built. Toward the interior of the wall 120, the window frame 110 may have a dry wall return as part of the extrusion or mold that will cover the edge of the drywall. The window frame 110 may include a plurality of kerf grooves 410a, 410b, 410c. A kerf groove 410c of the plurality of kerf grooves 410a-c may allow a liner or drywall to be attached and to cover the frame 110.

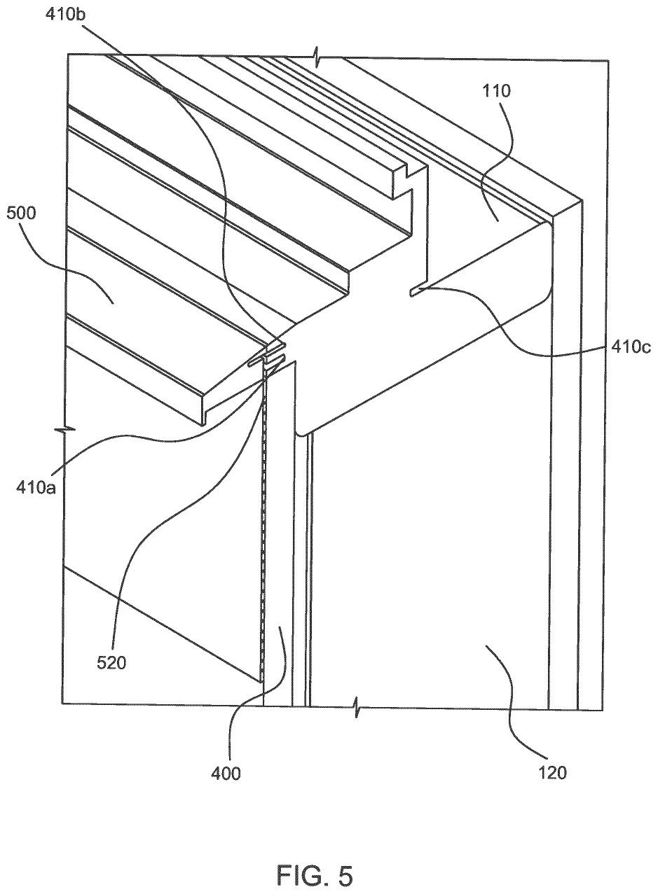

FIG. 5 shows a section of the window frame 110 with trim 500 attached. The window frame 110 may include at least two kerfs 410a, 410b or notches located on the outside face of the frame 110. The outer kerf groove 410a may allow a flexible flashing system 520 to connect to the frame 110 and form a water barrier with the wall 110. The outer kerf groove 410a is “outer” on the frame 110 with respect to the window 130. The inner kerf groove 410b allows for various exterior trim 500 to be attached to the frame 110 that overlaps any wall cladding 400. The wall cladding 400 may be siding, stucco, etc. The inner kerf groove 410b is “inner” on the frame 110 with respect to the window 130. The trim 500 may have a simple shape as shown in FIG. 5 or could have optional shapes such as a brickmould or large flat “cedar trim” look or others. The trim 500 is attached to the frame 110 prior to the cladding 400 being installed. However, the wall 110 may be shipped to the final location without the trim 500 attached.

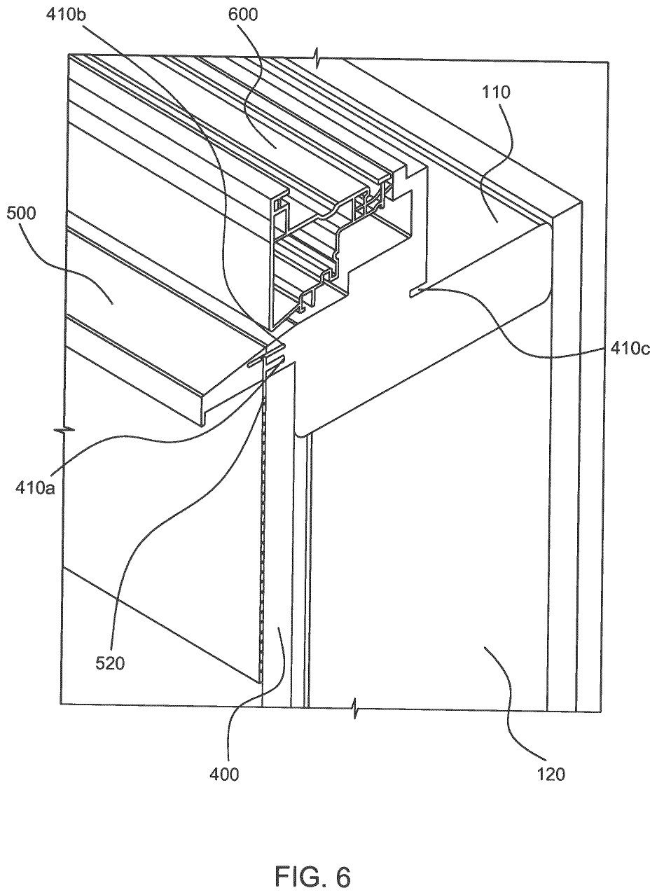

FIG. 6 shows a section of the window frame 110 with an accessory 600 attached to the frame 110. The integrated window and wall system 100 allows accessories 600 to be attached to the window frame 110. The accessories 600 may include mounts for blinds, shades and retractable screens. The window frame 110 connects to power for options and accessories 600 that can connect through the power system. Theses accessories 600 may include dynamic glass, transparent or semi-transparent photovoltaic glass, motorized shades and blinds, motorized or actuation controlled windows, speakers, lighting, security, etc.

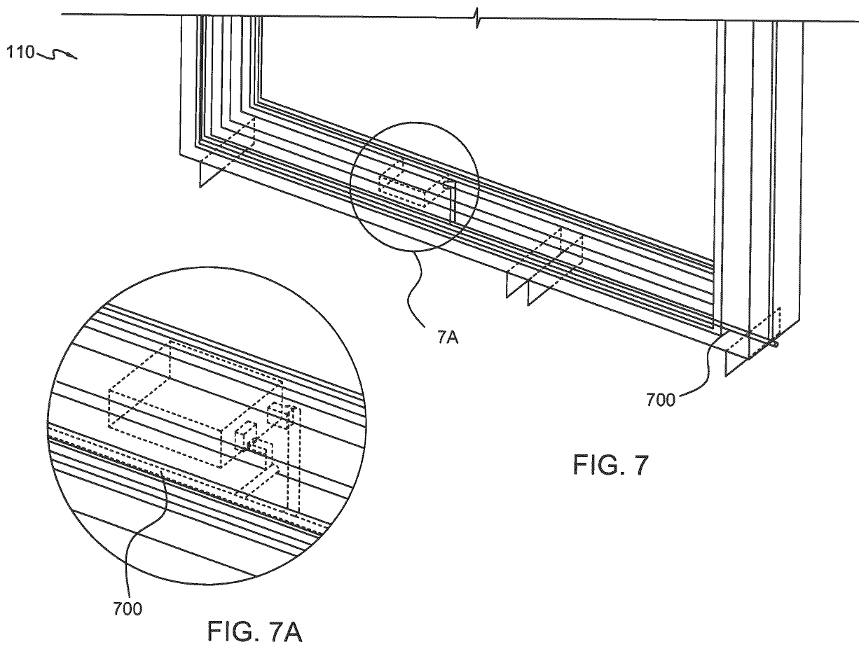

FIG. 7 shows the integrated power system 700 in the window frame 110. The integrated power system 700 may be molded into the frame 110. The integrated power system 700 may be a wiring harness with a central input power and routed to where the power is needed for each accessory 600. The integrated power system 700 may be a bus-bar where a central backbone of power is routed around the frame 110 with leads coming off of the bus-bar at each area there is a need for power connection.

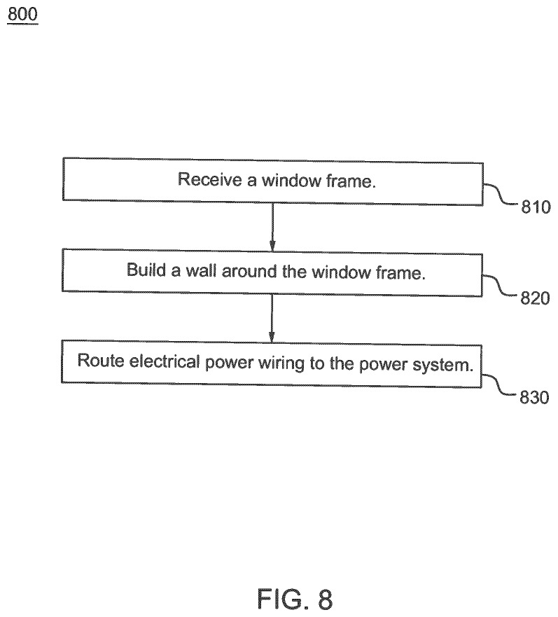

FIG. 8 shows a flow chart of assembling a prefabricated integrated window and wall 800. The window and wall assembled in the method 800 include the same details and embodiments previously described for the system 100. In step 810 of the method 800, a window frame 110 is received. The window frame 110 includes the same details and embodiments previously discussed including a sill 200 with tabs and a frame head 210 with a channel. In step 820, the wall 120 is built around the window frame 110. Wall frame components of the wall 120 attach to the tabs of the sill 200 and the channel of the frame head 210. In step 830, electrical power wiring is routed to the power system 700 in the window frame 110. The method 800 may also include attaching accessories 600 to the window frame 110. The method 800 may further include connecting the accessories 600 to the power system 700 to supply electric to electrical accessories.

Having thus described in detail a preferred selection of embodiments of the present invention, it is to be appreciated and will be apparent to those skilled in the art that many physical changes could be made to the prefabricated integrated window and wall system and method of assembly without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A prefabricated integrated window system and wall system comprising:
a wall system comprising:
a wall header;
wall frame components; and
electrical power wiring;
a window system integrated with the wall system, the window system comprising a window frame, the window frame comprising:
a frame head comprising a channel in which to receive the wall header and connect the wall header of the wall system to the window frame; and
a power system integrated within the window frame and coupled to the electrical power wiring, the integrated power system comprising: one of a wiring harness and a bus bar routed around the window frame, and a plurality of leads coupled thereto each to connect power received from the electrical power wiring to an electronically controlled accessory attached to the window frame.

2. The prefabricated integrated window system and wall system of claim 1 further comprising an accessory coupled to the window frame, the accessory selected from a group of accessories or electronically controlled accessories consisting of: a roller shade, blind housings, retractable screens, mounts for shades, blinds and retractable screens, dynamic glass, transparent or semitransparent photovoltaic glass, motorized shades and blinds, and motorized or actuation controlled windows, speakers, lighting, and security, and any combinations thereof.

3. The prefabricated integrated window system and wall system of claim 1 wherein the window frame includes an outer kerf groove configured to allow a flexible flashing system to connect to the window frame and form a water barrier with the wall.

4. The prefabricated integrated window system and wall system of claim 1 wherein the window frame includes an inner kerf groove configured to allow various exterior trim to be attached that overlaps wall cladding.

5. The prefabricated integrated window system and wall system of claim 4 wherein the exterior trim has a shape of at least one of brickmould and large flat cedar trim.

6. The prefabricated integrated window system and wall system of claim 1 further comprising a window selected from a group of windows consisting of: a direct glazed fixed window, a sash-set fixed window, a projection window, and a sliding window.

7. The prefabricated integrated window system and wall system of claim 1 wherein the window frame is molded.

8. The prefabricated integrated window system and wall system of claim 1 wherein the wall is constructed from one of wood or cold formed steel.

9. The prefabricated integrated window system and wall system of claim 1, wherein the window frame further comprises a sill comprising tabs coupled to the wall frame components of the wall system.

10. A method of assembling a prefabricated integrated window system and wall system comprising:
receiving a window frame configured to hold a variety of different windows and including a frame head and a power system comprising: one of a wiring harness and a bus bar routed around the window frame, and a plurality of leads coupled thereto each to connect to an electronically controlled accessory attached to the window frame;
building a wall comprising wall frame components, electrical power wiring, and a wall header around the window frame by attaching the wall frame components to the window frame, receiving the wall header in the channel of the frame head, and attaching the wall header to the channel of the frame head; and
coupling the electrical power wiring to the power system in the window frame.

11. The method of claim 10 further comprising the window frame receiving at least one of electronics, roller shade and blind housings, and retractable screens.

12. The method of claim 10 further comprising cutting an outer kerf groove in the window frame, and connecting a flexible flashing system to the window frame via the outer kerf groove form a water barrier with the wall.

13. The method of claim 10 further comprising cutting an inner kerf groove in the window frame and connecting exterior trim to the window frame via the inner kerf groove that overlaps wall cladding.

14. The method of claim 13 wherein the exterior trim has a shape of at least one of brickmould and large flat cedar trim.

15. The method of claim 10 wherein the electronically controlled accessory comprises dynamic glass, transparent or semi-transparent photovoltaic glass, motorized shades and blinds, motorized or actuation controlled windows, speakers, lights, security, and combinations thereof.

16. The method of claim 10 wherein the variety of different windows includes direct glazed fixed, sash-set fixed, projection windows, and sliding windows.

17. The method of claim 10 wherein the window frame is molded.

18. The method of claim 10 wherein the wall is at least one of wood or cold formed steel.

19. The method of claim 10, wherein receiving the window frame configured to hold the variety of different windows and including the frame head comprising the channel and the power system, comprises receiving the window frame configured to hold the variety of different windows and including the frame head comprising the channel, and a sill comprising tabs projecting therefrom.
